(19) United States
(12) Patent Application Publication
(10) Pub. No.: US 2025/0076736 A1
(43) Pub. Date: Mar. 6, 2025

(54) DISPLAY OPTICAL SYSTEM AND DISPLAY APPARATUS

(71) Applicant: CANON KABUSHIKI KAISHA, Tokyo (JP)

(72) Inventor: Kazuto ISHIDA, Tochigi (JP)

(21) Appl. No.: 18/817,296

(22) Filed: Aug. 28, 2024

(30) Foreign Application Priority Data
Aug. 31, 2023 (JP) 2023-140624

(51) Int. Cl. G03B 13/06

(52) U.S. Cl. CPC G03B 13/06

(57) ABSTRACT

A display optical system includes a diffractive surface with a controlled wavelength dispersion characteristic. A predetermined inequality is satisfied.

### BACKGROUND

### Technical Field

One of the aspects of the embodiments relates to a display optical system suitable for a display apparatus, such as an electronic viewfinder (EVF).

### Description of Related Art

One display optical system configured to enable an observer to observe an image displayed on a display panel includes a lens having strong positive refractive power for enabling the observer to observe a magnified image, and a lens having negative refractive power for correcting chromatic aberration and astigmatism caused by that positive refractive power. Japanese Patent Laid-Open No. 2014-202770 discloses a display optical system that includes, in order from the observer side, a first lens having positive refractive power, a second lens having negative refractive power and a meniscus shape with a concave surface facing the display panel side, and a third lens having positive refractive power. Japanese Patent Laid-Open No. 2020-154190 discloses a display optical system that has two positive lenses, one negative lens, and a diffractive surface.

U.S. Pat. No. 10,670,782 discloses a diffractive surface different from the conventional diffractive surfaces in which a wavelength dispersion characteristic is controlled using a fine shape of a quarter wavelength size.

The display optical system disclosed in Japanese Patent Laid-Open No. 2014-202770 is not enough to correct lateral chromatic aberration and astigmatism. The display optical system disclosed in Japanese Patent Laid-Open No. 2020-154190 is enough to correct lateral chromatic aberration using a diffractive surface, but is not enough to correct astigmatism.

### SUMMARY

A display optical system according to one aspect of the disclosure is configured to display an image displayed on a display surface, on an observation side. The display optical system includes a diffractive surface (or a metasurface) with a controlled wavelength dispersion characteristic. The following equation is satisfied:

$$\frac{1}{{v}_{o}} = \frac{{ψ}_{F} - {ψ}_{C}}{{ψ}_{d}} = \frac{{λ}_{F} P ( {λ}_{F} ) - {λ}_{C} P ( {λ}_{C} )}{{λ}_{d} P ( {λ}_{d} )} ,$$

where ν₀ is an Abbe number of the diffractive surface (or the metasurface), a reference wavelength is d-line, primary dispersion is F-line and C-line, Ψ_{d}, Ψ_{F}, and Ψ_{C} are optical path difference functions for the d-line, the F-line, and the C-line, respectively, λ_{d}, λ_{F}, and λ_{C} are incident wavelengths of the d-line, the F-line, and the C-line, respectively, P(λ_{d}), P(λ_{F}), and P(λ_{C}) are optical path difference dispersions of a surface for the d-line, the F-line, and the C-line, respectively, and the following inequality is satisfied:

$$- 0.2 < 1 / {v}_{0} < 0.2 .$$

A display apparatus having the above display optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a display optical system according to Example 1.

FIG. 2 is an aberration diagram of the display optical system according to Example 1.

FIG. 3 is a sectional view of a display optical system according to Example 2.

FIG. 4 is an aberration diagram of the display optical system according to Example 2.

FIG. 5 is a sectional view of a display optical system according to Example 3.

FIG. 6 is an aberration diagram of the display optical system according to Example 3.

FIG. 7 is a sectional view of a display optical system according to Example 4.

FIG. 8 is an aberration diagram of the display optical system according to Example 4.

FIG. 9 is a sectional view of a display optical system according to Example 5.

FIG. 10 is an aberration diagram of the display optical system according to Example 5.

FIG. 11 is a sectional view of a display optical system according to Example 6.

FIG. 12 is an aberration diagram of the display optical system according to Example 6.

FIG. 13 is a sectional view of a display optical system according to Example 7.

FIG. 14 is an aberration diagram of the display optical system according to Example 7.

FIG. 15 illustrates an image pickup apparatus having an electronic viewfinder including the display optical system according to this example.

### DESCRIPTION OF THE EMBODIMENTS

Referring now to the accompanying drawings, a description will be given of embodiments according to the disclosure. Before specific Examples 1 to 7 are described, a description will now be given of matters common to each example.

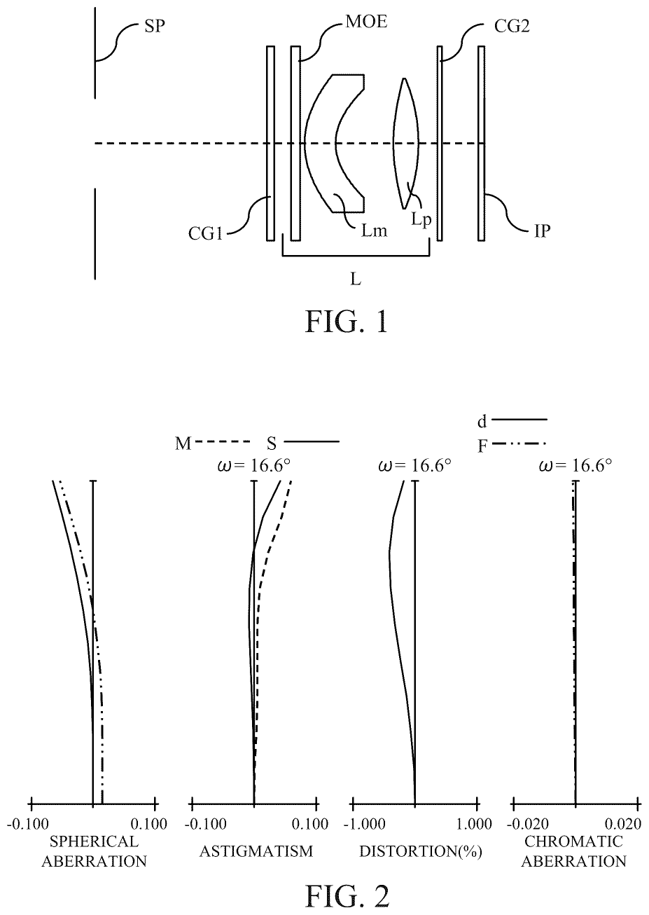

FIGS. 1, 3, 5, 7, 9, 11, and 13 illustrate the configurations of display optical systems L according to Examples 1 to 7, respectively. The display optical system L according to each example is used for an electronic viewfinder (EVF) of an image pickup apparatus such as a digital camera or video camera.

In each figure, a left side is an observation side (exit pupil side or eyepoint side), and a right side is a display surface side (object side or panel side). SP represents an observation surface (exit pupil plane or eyepoint) where the observer places his eye (pupil). MOE is a diffractive surface with a controlled wavelength dispersion characteristic (simply referred to as dispersion controlled hereinafter), and Lm is a meniscus lens. IP is a display surface of a display element. The display element includes a liquid crystal panel, an organic EL element, etc. The display optical system L includes at least a diffractive surface MOE and a meniscus lens Lm.

CG1 is a first cover glass that prevents dirt and dust from entering the display optical system from the observation side. CG2 is a second cover glass that prevents dirt and dust from adhering to the display surface.

An optical path difference function y of a dispersion-controlled diffractive surface can be defined as follows:

$$ψ ≡ m \frac{λ}{{λ}_{0}} P ( λ ) {ψ}_{0}$$

$$\{ \begin{matrix}P ( λ ) \neq 1 \\ P ( {λ}_{0} ) = 1\end{matrix}$$

where m is a diffraction order, λ₀ is a designed wavelength of the diffractive surface, λ is an incident wavelength, P(λ) is an optical path difference dispersion of a surface, and Ψ₀ is an optical path difference function of the surface at a designed wavelength.

In a case where the surface is a rotationally symmetric surface, which is frequently used, the optical path difference function Ψ₀ of the surface at the designed wavelength is usually expressed by the following polynomial:

$${ψ}_{0} = {U}_{2} {h}^{2} + {U}_{4} {h}^{4} + {U}_{6} {h}^{6} + ⋯$$

where h is a distance from the optical axis.

A focal length fₘₒₑ of a dispersion-controlled diffractive surface can be expressed as follows using a quadratic coefficient U₂ of an optical path difference function of a surface at the designed wavelength expressed by a polynomial:

$$\frac{1}{{f}_{m o e}} = - 2 m \frac{λ}{{λ}_{0}} P ( λ ) {U}_{2}$$

Assume that a reference wavelength of the dispersion-controlled diffractive surface is the d-line (wavelength 587.6 nm) and the primary dispersion is the F-line (wavelength 486.1 nm) and C-line (wavelength 656.3 nm). Then, the Abbe number ν₀ can be written as follows:

$$\frac{1}{{v}_{o}} = \frac{{ψ}_{F} - {ψ}_{C}}{{ψ}_{d}} = \frac{{λ}_{F} P ( {λ}_{F} ) - {λ}_{C} P ( {λ}_{C} )}{{λ}_{d} P ( {λ}_{d} )}$$

where Ψ_{d}, Ψ_{F}, and Ψ_{C} are optical path difference functions for the d-line, F-line, and C-line, respectively, and λ_{d}, λ_{F}, and λ_{C} represent incident wavelengths for the d-line, F-line, and C-line, respectively.

Assume that a reference wavelength of the dispersion-controlled diffractive surface is the d-line and the primary dispersion is the g-line (wavelength 435.8 nm) and F-line. Then, the Abbe number ν_{0,gF} in the short wavelength range below the F-line can be expressed as follows:

$$\frac{1}{{v}_{o , gF}} = \frac{{ψ}_{g} - {ψ}_{F}}{{ψ}_{d}} = \frac{{λ}_{g} P ( {λ}_{g} ) - {λ}_{F} P ( {λ}_{F} )}{{λ}_{d} P ( {λ}_{d} )}$$

where Ψ_{d}, Ψ_{g}, and Ψ_{F} are optical path difference functions for the d-line, g-line, and F-line, respectively, and λ_{d}, λ_{g}, and λ_{F} represent incident wavelengths for the d-line, g-line, and F-line, respectively.

Each example uses the first-order diffracted light for the design, and thus sets the diffraction order m to 1. The d-line is used as the incident wavelength in determining the designed wavelength λ₀ and focal length.

In the display optical system according to each example, it is assumed that the observer observes a small display panel with a diagonal length of about 10 mm at an angle of field of about 35 degrees in observing a magnified image. A strong positive refractive power is used to observe a magnified image. As a result, the optical performance deteriorates in a peripheral area distant from the optical axis, because as a height from the optical axis increases, large lateral chromatic aberration and astigmatism occur. To improve such lateral chromatic aberration and astigmatism, the display optical system according to each example places a lens with a dispersion-controlled diffractive surface MOE between the observation surface and the display surface. The diffractive surface MOE can control the wavelength dispersion characteristic to an arbitrary value, and thus can effectively correct the lateral chromatic aberration. The diffractive surface MOE controls a light traveling direction by diffraction, and can effectively correct the lateral chromatic aberration. Since the Petzval term in the diffractive surface MOE is zero, the astigmatism and curvature of field of the display optical system can be satisfactorily corrected.

The display optical system has a wholly strong positive refractive power, and thus may use a dispersion-controlled diffractive surface MOE, which has the aberration reducing effect, for the surface having positive refractive power. Thereby, the aberration can be suppressed, which would otherwise occur with a refractive lens having positive refractive power (a lens having a refractive action rather than a diffractive action), a display optical system with satisfactorily reduced aberration can be obtained.

With the dispersion-controlled diffractive surface MOE alone, spherical aberration and curvature of field occur in a deviated manner. Therefore, the peripheral curvature of field is tilted relative to the best image plane on the optical axis, and it becomes difficult to simultaneously correct both on-axis and peripheral aberrations. To effectively reduce aberrations, curvature of field is to be corrected, and for this purpose at least one refractive lens may be provided.

In particular, the refractive lens has a meniscus shape and is disposed adjacent to a lens with a dispersion-controlled diffractive surface MOE. Thereby, curvature of field can be properly corrected.

The lens placed closest to the observer may have positive refractive power. By placing the positive lens at a position distant from the display surface, it becomes easier to secure a lens back (a distance from the positive lens to the display surface) with a relatively weak refractive power, and an increase in aberration can be suppressed. In a case where a long lens back can be secured, there is a high degree of freedom in placing the meniscus lens Lm between the positive lens and the display surface, and the meniscus lens Lm can be placed at a position suitable for aberration correction.

Moving the entire display optical system in the optical axis direction (toward the observation side and the display surface side) along with the lens having a dispersion-controlled diffractive surface and the meniscus lens can perform diopter adjustment with little performance deterioration. Moving the display optical system toward the observation side can provide positive diopter correction, and moving it toward the display surface side can provide negative diopter correction.

The dispersion-controlled diffractive surface MOE may have a planar shape. The dispersion-controlled diffractive surface having a curvature functions as a refractive surface. Thereby, a part of the refractive power that is to be generated by diffraction in the dispersion-controlled diffractive surface is shared by the refractive surface, and the effects of wavelength dispersion control and Petzval reduction of the dispersion-controlled diffractive surface are reduced. In addition, since the fine shape of the dispersion-controlled diffractive surface is created using a semiconductor manufacturing process, creating a fine shape on a curved surface is technically difficult.

By properly setting the Abbe number and focal length of the dispersion-controlled diffractive surface MOE, the focal length of the meniscus lens Lm, and the overall length of the display optical system L, each example can provide a display optical system L in which lateral chromatic aberration and astigmatism are satisfactorily corrected. More specifically, it is preferable to satisfy at least one of the following inequalities (1) to (5):

$$- 0.2 < 1 / {v}_{0} < 0.2 \qquad ( 1 )$$

$$0.7 < {f}_{m o e} / f < 4. \qquad ( 2 )$$

$$- 4 < f m e n i s / f < 4 \qquad ( 3 )$$

$$0.6 < OL / f < 1.4 \qquad ( 4 )$$

$$- 0. 2 < 1 / {v}_{0 , g F} < 0.02 \qquad ( 5 )$$

In the above inequalities, vo is the Abbe number of the dispersion-controlled diffractive surface MOE in a case where the reference wavelength is the d-line and the primary dispersion is the F-line and C-line. fₘₒₑ is the focal length of the dispersion-controlled diffractive surface MOE. fmenis is the focal length of the meniscus lens Lm. f is the focal length of the entire display optical system L. OL is the overall optical length of the display optical system L, and is the distance on the optical axis (distance between the vertices of the surface) between an optical surface closest to the display surface and an optical surface farthest from the display surface among the optical surfaces (optical surfaces of the lens with the dispersion-controlled diffractive surface and refractive lenses) included in the display optical system. ν_{0,gF} is the Abbe number in the short wavelength range below the F-line of the dispersion-controlled diffractive surface MOE in a case where the reference wavelength is the d-line and the primary dispersion is the g-line and F-line.

Inequality (1) defines a proper range for lateral chromatic aberration correction of the dispersion, which is a reciprocal of the Abbe number vo of the dispersion-controlled diffractive surface MOE. In a case where 1/ν₀ becomes lower than the lower limit of inequality (1), the negative dispersion of the diffractive surface MOE increases, and a chromatic aberration correction amount by the diffractive surface MOE increases. As a result, the chromatic aberration is overcorrected in the entire display optical system. In a case where 1/ν₀ becomes higher than the upper limit of inequality (1), the positive dispersion of the diffractive surface MOE increases, and a chromatic aberration correction amount by the diffractive surface MOE reduces, like that of a normal refractive lens. As a result, the chromatic aberration is under corrected in the entire display optical system.

Inequality (2) defines a proper range for astigmatism correction of the focal length of the dispersion-controlled diffractive surface MOE. In a case where fₘₒₑ/f becomes lower than the lower limit of inequality (2), the refractive power of the diffractive surface MOE becomes weak and the effect of reducing astigmatism caused by diffraction becomes insufficient. In a case where fₘₒₑ/f becomes higher than the upper limit of inequality (2), the refractive power of the diffractive surface MOE becomes strong and a tilt amount of the image plane toward the under correction side increases. As a result, large astigmatism occurs according to the tilt amount, and astigmatism of the entire display optical system increases.

Inequality (3) defines a proper range for field curvature correction of the focal length of the meniscus lens Lm. In a case where fmenis/f becomes lower than the lower limit of inequality (3), the negative refractive power of the meniscus lens Lm becomes strong, and the meniscus lens Lm cause overcorrection of the lateral chromatic aberration and curvature of field on the overcorrection side. In a case where fmenis/f becomes higher than the upper limit of the equation, the positive refractive power of the meniscus lens Lm becomes strong, and causes lateral chromatic aberration and curvature of field on the under correction side.

Inequality (4) defines a proper range for aberration correction of the overall optical length of the display optical system L. In a case where OL/f becomes lower than the lower limit of inequality (4), the overall optical length becomes too short, and the lens spacing, the curvature of the optical surface reduces, and it becomes difficult to properly correct various aberrations such as spherical aberration and curvature of field. In a case where OL/f becomes higher than the upper limit of inequality (4), the overall optical length becomes too long, resulting in an unbalanced power arrangement in which the positive refractive power of the observation side is weak and the positive refractive power of the lens on the display surface side is strong. The strong refractive power of the lens on the display surface side generates various aberrations such as spherical aberration and curvature of field, and it becomes difficult to obtain excellent optical performance.

Inequality (5) defines a proper range for lateral chromatic aberration correction of dispersion, which is a reciprocal of the Abbe number ν_{0,gF} in the short wavelength region of the dispersion-controlled diffractive surface MOE. In a case where 1/ν_{0,gF} becomes lower than the lower limit of inequality (5), the negative dispersion in the short wavelength region of the diffractive surface MOE becomes too large, and a chromatic aberration correction amount in the short wavelength region by the diffractive surface MOE becomes large. As a result, the chromatic aberration in the short wavelength region of the entire display optical system becomes overcorrected. In a case where 1/ν_{0,gF} becomes higher than the upper limit of inequality (5), the positive dispersion in the short wavelength region of the diffractive surface MOE becomes too large, and the chromatic aberration of the entire display optical system becomes under corrected.

Inequalities (1) to (5) may be replaced with inequalities (1a) to (5a) below:

$$- 0.15 < 1 / {v}_{0} < 0 \text{.10} \qquad ( 1 a )$$

$$0.75 < {f}_{moe} / f < 3.9 \qquad ( 2 a )$$

$$- 3.7 < fmenis / f < 3.7 \qquad ( 3 a )$$

$$0.65 < OL / f < 1.3 \qquad ( 4 a )$$

$$- 0. 15 < 1 / {v}_{0 , gF} < 0.015 \qquad ( 5 a )$$

Inequalities (1) to (5) may be replaced with inequalities (1b) to (5b) below:

$$- 0.10 < 1 / {v}_{0} < 0 \text{.03} \qquad ( 1 b )$$

$$0.8 < {f}_{moe} / f < 3.8 \qquad ( 2 b )$$

$$- 3.2 < fmenis / f < 3.2 \qquad ( 3 b )$$

$$0.7 < OL / f < 1.2 \qquad ( 4 b )$$

$$- 0. 1 < 1 / {v}_{0 , gF} < 0.01 \qquad ( 5 b )$$

A detailed description will now be given of Examples 1 to 7. After the description according to Example 7, a description will be given of numerical examples 1 to 7 corresponding to Examples 1 to 7, respectively.

In each numerical example, the diagonal length of the display surface is twice as long as the maximum image height. Surface number i represents the order of the optical surface counted from the observation (eye point EP) side, and r represents a paraxial radius of curvature of the i-th optical surface. d represents an interval (distance or spacing) on the optical axis between i-th and (i+1)-th surfaces. nd and vd respectively represent a refractive index for the d-line (wavelength 578.6 nm) and the Abbe number based on the d-line of the glass material between the i-th surface and the (i+1)-th surface.

The Abbe number vd based on the d-line is expressed as follows:

$$vd = ( Nd - 1 ) / ( NF - NC )$$

where Nd, NF, and NC are refractive indices for the d-line, F-line (wavelength 486.1 nm), and C-line (wavelength 656.3 nm).

An asterisk “*” next to the surface number means that that surface has an aspheric shape. The aspheric shape is expressed by the following equation:

$$x = ( {h}^{2} / R ) / [ 1 + {\{ 1 - ( 1 + K ) {( h / R )}^{2} \}}^{1 / 2} ] + A 4 \cdot {h}^{4} + A 6 \cdot {h}^{6} + A 8 \cdot {h}^{8}$$

where x is a displacement amount from a surface vertex in the optical axis direction, h is a height from the optical axis in the direction orthogonal to the optical axis, a light traveling direction is set positive, R is a paraxial radius of curvature, K is a conic constant, and A4 to A8 are aspheric coefficients. “e±M” in the conic constant and aspheric coefficients means ×10^{±M}.

The optical path difference function of the surface at the designed wavelength is expressed by the following expression:

$$ψ 0 = U 2 \cdot {h}^{2} + U 4 \cdot {h}^{4} + U 6 \cdot {h}^{6} + U 8 \cdot {h}^{8}$$

where U2 to U8 are the optical path difference function coefficients of the surface.

The (diffraction) attached to the surface number indicates that that surface is optically designed using an optical path difference function of a surface. An optical path difference dispersion of a surface P(λ) is expressed by an equation with the incident wavelength λ as a variable. In calculating the optical path difference dispersion of the surface, the incident wavelength λ is calculated using the unit [μm].

Each numerical example makes variable the surface distance for diopter adjustment, and values of the corresponding surface distance and variable surface distance are illustrated for each diopter state of 0 m⁻¹ (standard diopter),−3 m⁻¹, −1 m⁻¹, and +1 m⁻¹.

Table 1 summarizes values relating to inequalities (1) to (5) in numerical examples 1 to 7.

FIGS. 2, 4, 6, 8, 10, 12, and 14 illustrate longitudinal aberration diagrams (spherical aberration, astigmatism, distortion, and chromatic aberration) for the display optical systems according to numerical examples 1 to 7 in a case where the diopter is 0 m⁻¹. The vertical axis Fno of the spherical aberration diagram represents the F-number, and the vertical axis ω of each of the astigmatism, distortion, and chromatic aberration diagrams represents the half angle of view (half angle of field: unit: °). The horizontal axis indicates an aberration amount of each aberration. In the spherical aberration diagrams, a solid line indicates a spherical aberration amount for the d-line, and an alternate long and two short dashes line indicates a spherical aberration amount for the F-line. In the astigmatism diagram, a solid line S indicates an astigmatism amount on the sagittal image plane, and a dashed line M indicates an astigmatism amount on the meridional image plane. The distortion aberration diagram illustrates a distortion amount for the d-line. The chromatic aberration diagram illustrates a lateral chromatic aberration amount for the F-line.

### EXAMPLE 1

The display optical system L according to Example 1 (numerical example 1) illustrated in FIG. 1 includes, in order from the observation side to the display surface side, a lens with a dispersion-controlled diffractive surface MOE, a meniscus lens Lm with a convex surface facing the observation side, and a positive lens Lp.

### EXAMPLE 2

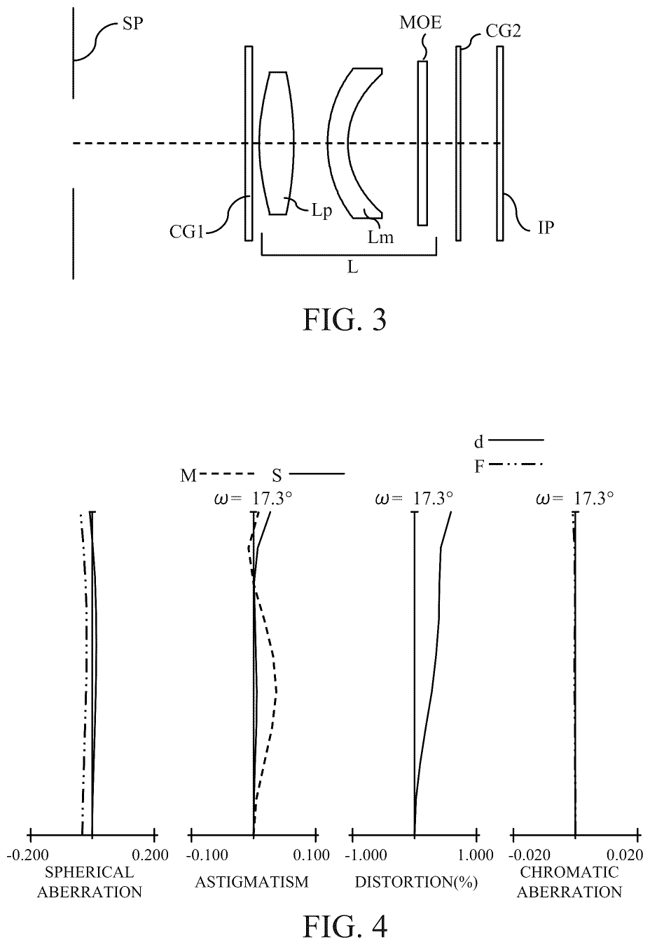

The display optical system L according to Example 2 (numerical example 2) illustrated in FIG. 3 includes, in order from the observation side to the display surface side, a positive lens Lp, a meniscus lens Lm with a convex surface facing the observation side, and a lens with a dispersion-controlled diffractive surface MOE.

### EXAMPLE 3

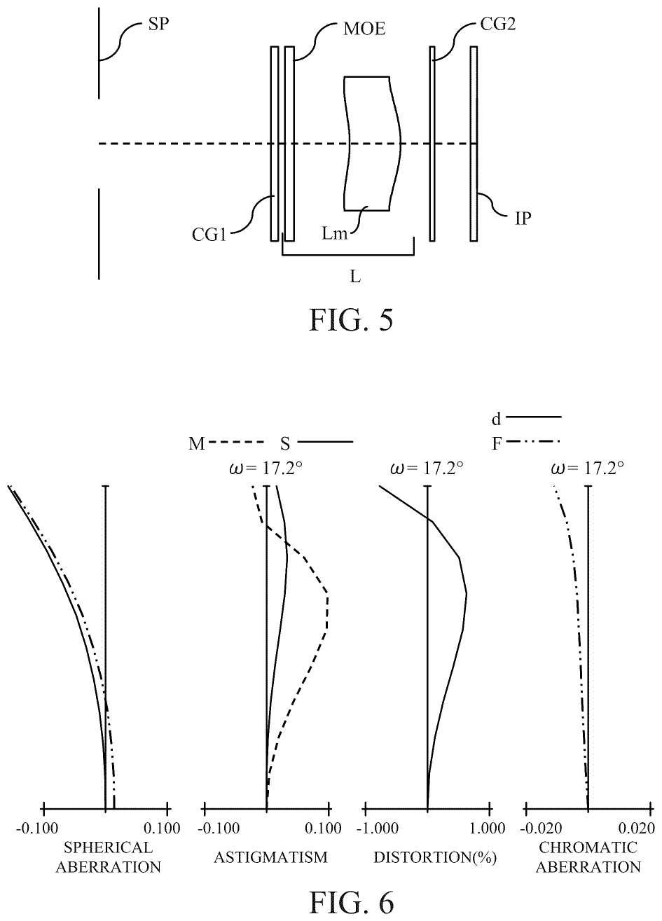

The display optical system L according to Example 3 (numerical example 3) illustrated in FIG. 5 includes, in order from the observation side to the display surface side, a lens with a dispersion-controlled diffractive surface MOE, and a meniscus lens Lm with a convex surface facing the display surface side.

### EXAMPLE 4

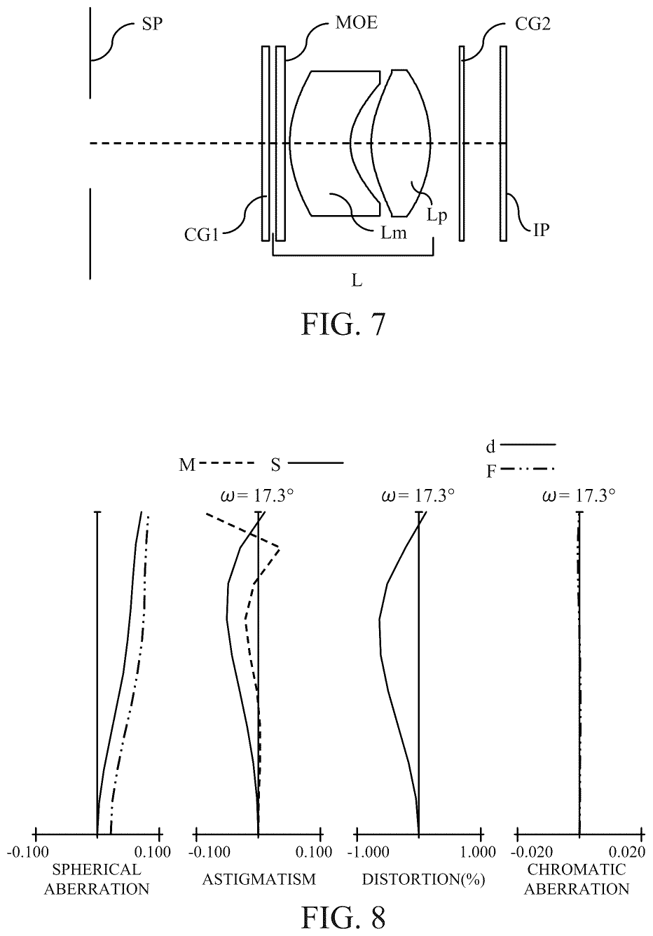

The display optical system L according to Example 7 (numerical example 4) illustrated in FIG. 7 includes, in order from the observation side to the display surface side, a lens with a dispersion-controlled diffractive surface MOE, a meniscus lens Lm with a convex surface facing the observation side, and a positive lens Lp.

### EXAMPLE 5

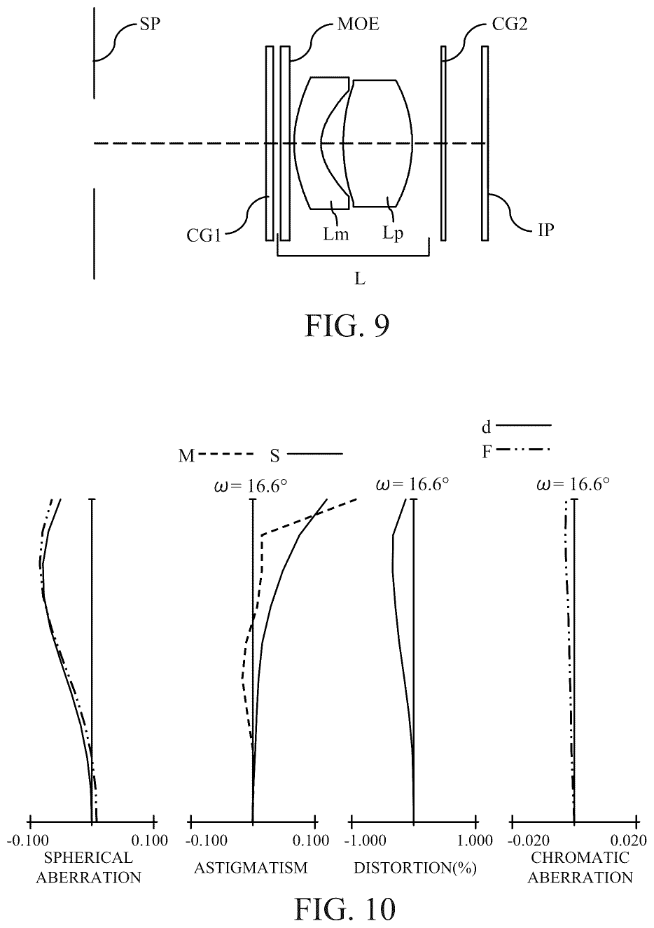

The display optical system L according to Example 5 (numerical example 5) illustrated in FIG. 9 includes, in order from the observation side to the display surface side, a lens with a dispersion-controlled diffractive surface MOE, a meniscus lens Lm with a convex surface facing the observation side, and a positive lens Lp.

### EXAMPLE 6

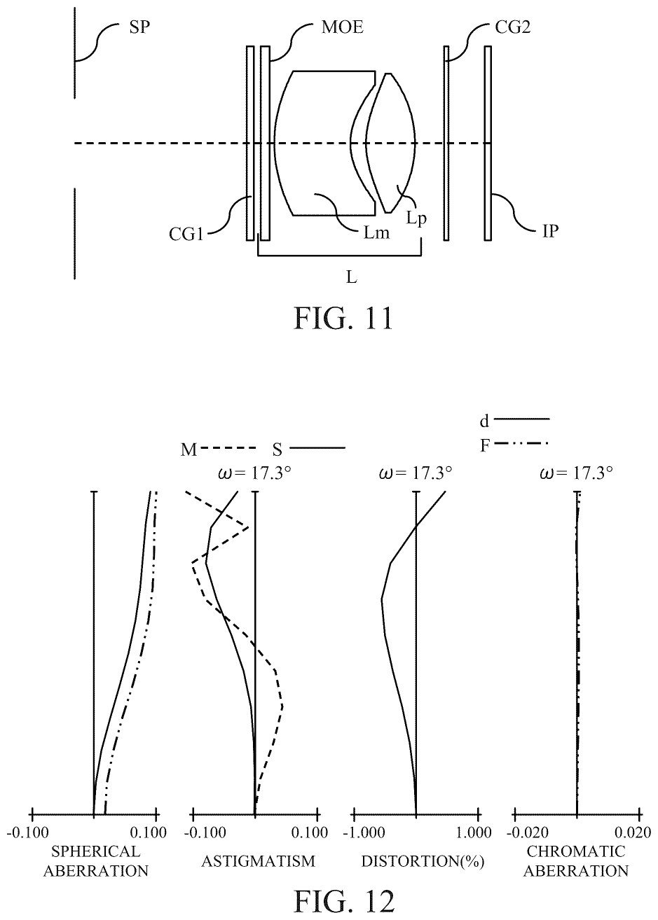

The display optical system L according to Example 6 (numerical example 6) illustrated in FIG. 11 includes, in order from the observation side to the display surface side, a lens with a dispersion-controlled diffractive surface MOE, a meniscus lens Lm with a convex surface facing the observation side, and a positive lens Lp.

### EXAMPLE 7

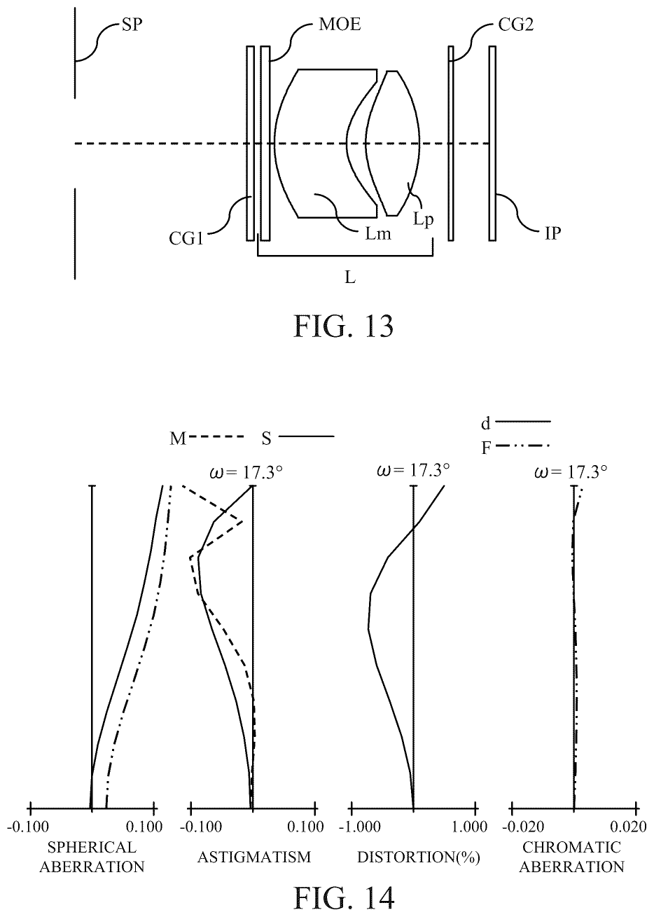

The display optical system L according to Example 7 (numerical example 7) illustrated in FIG. 13 includes, in order from the observation side to the display surface side, a lens with a dispersion-controlled diffractive surface MOE, a meniscus lens Lm with a convex surface facing the observation side, and a positive lens Lp.

In each example, the optical path difference function of the dispersion-controlled diffractive surface may be realized by a metasurface in which a phase delay amount of the meta-atoms is calculated for each wavelength and the meta-atoms are arranged so as to control the wavelength dispersion characteristic of the surface. The metasurface may be a so-called single-layer metasurface consisting of one layer, or a so-called stacked metasurface consisting of multiple layers.

NUMERICAL EXAMPLE 1
UNIT: mm
Diopter: 0 m⁻¹ Focal Length f: 16.72 Pupil Diameter: 10
Diagonal Length of Display Surface: 9.98 Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4 | ∞ | 1.00 | 1.45867 | 67.9 |
| 5 (diffraction) | ∞ | 0.50 | | |
| 6* | 9.021 | 3.41 | 1.63400 | 23.9 |
| 7* | 5.492 | 6.40 | | |
| 8* | 21.184 | 2.76 | 1.53504 | 55.7 |
| 9 | −18.659 | (Variable) | | |
| 10 | ∞ | 0.50 | 1.52310 | 65.0 |
| 11 | ∞ | 4.00 | | |
| 12 | ∞ | 0.70 | 1.51680 | 64.2 |
| 13 | ∞ | (Variable) | | |
| Display Surface | ∞ | | | |

ASPHERIC DATA
5th Surface (Diffractive surface) Designed Wavelength: 0.58756 [μm]
U2 = −2.53150e−02 U4 = 4.38151e−05 U6 = −4.61170e−08
Optical Path Difference Dispersion of Surface λ Unit: [μm]
P(λ) = 0.58756/λ
P(λ_{d}) = 1.000000e+00
P(λ_{C}) = 8.952981e−01
P(λ_{F}) = 1.208640e+00
6th Surface
K = −1.59289e+00 A4 = 5.17471e−05 A6 = −1.38686e−07
A8 = 7.83985e−10
7th Surface
K = −9.99779e−01 A4 = −1.11333e−04
8th Surface
K = 0.00000e+00 A4 = −4.72586e−05 A6 = −4.71393e−07

| Variable Distance | 0 m⁻¹ | −3 | +1 | −1 |
|---|---|---|---|---|
| d3 | 1.86 | 2.73 | 1.58 | 2.14 |
| d9 | 2.12 | 1.24 | 2.39 | 1.83 |

NUMERICAL EXAMPLE 2
UNIT: mm
Diopter: 0 m⁻¹
Focal Length f: 16.0 Pupil Diameter: 10
Diagonal Length of Display Surface: 9.98
Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4* | 21.783 | 3.83 | 1.51630 | 64.2 |
| 5 | −36.536 | 3.72 | | |
| 6* | 13.943 | 2.23 | 1.63400 | 23.9 |
| 7* | 8.970 | 7.75 | | |
| 8 | ∞ | 1.00 | 1.45867 | 67.9 |
| 9 (diffraction) | ∞ | (Variable) | | |
| 10 | ∞ | 0.50 | 1.52310 | 65.0 |
| 11 | ∞ | 4.00 | | |
| 12 | ∞ | 0.70 | 1.51680 | 64.2 |
| 13 | ∞ | (Variable) | | |
| Display Surface | ∞ | | | |

ASPHERIC DATA
4th Surface
K = −8.93047e+00 A4 = 2.30097e−05 A6 = −5.57757e−07
A8 = 2.13321e−09
6th Surface
K = 0.00000e+00 A4 = 2.02707e−05
7th Surface
K = −5.74146e−01 A4 = 4.48809e−05
9th Surface (Diffractive surface) Designed Wavelength: 0.58756 [μm]
U2 = −3.85783e−02 U4 = 6.42238e−06 U6 = −1.21295e−07
Optical Path Difference Dispersion of Surface λ Unit: [μm]
P(λ) = 0.58756/2
P(λ_{d}) = 1.000000e+00
P(λ_{C}) = 8.952981e−01
P(λ_{F}) = 1.208640e+00

| Variable Distance | 0 m⁻¹ | −3 | +1 | −1 |
|---|---|---|---|---|
| d3 | 0.75 | 1.58 | 0.50 | 1.01 |
| d9 | 3.23 | 2.40 | 3.48 | 2.96 |

NUMERICAL EXAMPLE 3
UNIT: mm
Diopter: 0 m⁻¹ Focal Length f: 16.14 Pupil Diameter: 10
Diagonal Length of Display Surface: 9.98
Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4 | ∞ | 1.00 | 1.50000 | 50.0 |
| 5 (diffraction) | ∞ | 6.13 | | |
| 6* | −16.036 | 5.65 | 1.53504 | 55.7 |
| 7* | −11.106 | (Variable) | | |
| 8 | ∞ | 0.50 | 1.52310 | 65.0 |
| 9 | ∞ | 4.00 | | |
| 10 | ∞ | 0.70 | | |
| 11 | ∞ | (Variable) | 1.51680 | 64.2 |
| Display Surface | ∞ | | | |

ASPHERIC DATA
5th Surface (Diffractive surface) Designed Wavelength: 0.58756 [μm]
U2 = −2.96405e−02 U4 = 4.04969e−05 U6 = 3.44237e−08
U8 = 2.14619e−09
Optical Path Difference Dispersion of Surface λ Unit: [μm]
P(λ) = 0.58756/λ
P(λ_{d}) = 1.000000e+00
P(λ_{C}) = 8.952981e−01
P(λ_{F}) = 1.208640e+00
6th Surface
K = 0.00000e+00 A4 = 4.18678e−04 A6 = −1.10551e−08
A8 = −1.19198e−10
7th Surface
K = 0.00000e+00 A4 = 5.00954e−04 A6 = 9.64656e−09 A8 = 1.07173e−10

| Variable Distance | 0 m⁻¹ | −3 | +1 | −1 |
|---|---|---|---|---|
| d3 | 0.75 | 1.56 | 0.50 | 1.02 |
| d7 | 3.22 | 2.42 | 3.48 | 2.96 |

NUMERICAL EXAMPLE 4
UNIT: mm
Diopter: 0 m⁻¹ Focal Length f: 16.0 Pupil Diameter: 10
Diagonal Length of Display Surface: 9.98 Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4 | ∞ | 1.00 | 1.45867 | 67.9 |
| 5 (diffraction) | ∞ | 0.50 | | |
| 6* | 12.239 | 6.69 | 1.69053 | 23.7 |
| 7* | 5.578 | 2.32 | | |
| 8* | 10.203 | 6.52 | 1.61999 | 60.3 |
| 9 | −13.936 | (Variable) | | |
| 10 | ∞ | 0.50 | 1.52310 | 65.0 |
| 11 | ∞ | 4.00 | | |
| 12 | ∞ | 0.70 | 1.51680 | 64.2 |
| 13 | ∞ | (Variable) | | |
| Display Surface | ∞ | | | |

ASPHERIC DATA
5th Surface (Diffractive surface) Designed Wavelength: 0.58756 [μm]
U2 = −1.31462e−02 U4 = 2.61297e−05 U6 = 2.78964e−07
Optical Path Difference Dispersion of Surface λ Unit: [μm]
P(λ) = 11.98025λ¹⁰ − 112.89592λ⁹ + 636.82770λ⁸ −
2386.30684λ⁷ + 6238.00928λ⁶ −
11608.78282λ⁵ + 15381.84501λ⁴ − 14223.52046λ³ + 8743.65017λ² −
3216.93538λ + 536.92283
P(λ_{d}) = 1.000000e+00
P(λ_{C}) = 9.012396e−01
P(λ_{F}) = 1.200604e+00
6th Surface
K = −3.46571e+00 A4 = 6.60309e−05 A6 = −2.11974e−08
A8 = −2.01337e−09
7th Surface
K = −1.83926e+00 A4 = 4.84614e−05
8th Surface
K = 0.00000e+00 A4 = −3.80728e−04 A6 = 2.61749e−07

| Variable Distance | 0 m⁻¹ | −3 | +1 | −1 |
|---|---|---|---|---|
| d3 | 0.75 | 1.55 | 0.50 | 1.01 |
| d9 | 3.22 | 2.42 | 3.48 | 2.96 |

NUMERICAL EXAMPLE 5
UNIT: mm
Diopter: 0 m⁻¹ Focal Length f: 16.75 Pupil Diameter: 10
Diagonal Length of Display Surface: 9.98
Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4 | ∞ | 1.00 | 1.45867 | 67.9 |
| 5 (diffraction) | ∞ | 0.50 | | |
| 6* | 11.734 | 3.00 | 1.63400 | 23.9 |
| 7* | 4.745 | 2.44 | | |
| 8 | 19.285 | 7.61 | 1.53504 | 55.7 |
| 9 | −14.416 | (Variable) | | |
| 10 | ∞ | 0.50 | 1.52310 | 65.0 |
| 11 | ∞ | 4.00 | | |
| 12 | ∞ | 0.70 | 1.51680 | 64.2 |
| 13 | ∞ | (Variable) | | |
| Display Surface | ∞ | | | |

ASPHERIC DATA
5th Surface (Diffractive surface) Designed Wavelength: 0.58756 [μm]
A2 = −3.49300e−02 A4 = 1.49066e−04 A6 = −2.69699e−07
Optical Path Difference Dispersion of Surface λ Unit: [μm]
P(λ) = 24.42245λ¹⁰ − 295.85949λ⁹ + 1906.46259λ⁸ −
7762.66850λ⁷ + 21467.37098λ⁶ −
41580.67832λ⁵ + 56722.34999λ⁴ − 53578.32705λ³ + 33441.10472λ²
12429.40936λ + 2086.06535
P(λ_{d}) = 1.000000e+00
P(λ_{C}) = 8.910070e−01
P(λ_{F}) = 1.221691e+00
6th Surface
K = −5.53093e+00 A4 = −1.31491e−05 A6 = 1.60024e−06
A8 = −9.51399e−09
7th Surface
K = −1.72196e+00 A4 = 6.65881e−05

| Variable Distance | 0 m⁻¹ | −3 | +1 | −1 |
|---|---|---|---|---|
| d3 | 0.78 | 1.65 | 0.50 | 1.06 |
| d9 | 3.20 | 2.33 | 3.48 | 2.91 |

NUMERICAL EXAMPLE 6
UNIT: mm
Diopter: 0 m⁻¹
Focal Length f: 16.0 Pupil Diameter: 10
Diagonal Length of Display Surface: 9.98 Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4 | ∞ | 1.00 | 1.45867 | 67.9 |
| 5 (diffraction) | ∞ | 0.50 | | |
| 6* | 14.639 | 8.39 | 1.84666 | 23.8 |
| 7* | 6.623 | 1.74 | | |
| 8* | 9.698 | 5.40 | 1.60375 | 60.9 |
| 9 | −12.489 | (Variable) | | |
| 10 | ∞ | 0.50 | 1.52310 | 65.0 |
| 11 | ∞ | 4.00 | | |
| 12 | ∞ | 0.70 | 1.51680 | 64.2 |
| 13 | ∞ | (Variable) | | |
| Display Surface | ∞ | | | |

ASPHERIC DATA
5th Surface (Diffractive surface) Designed Wavelength: 0.58756 [μm]
U2 = −1.10948e−02 U4 = 6.84484e−06 U6 = 5.37528e−07
Optical Path Difference Dispersion of Surface λ Unit: [μm]
P(λ) = 12.24651λ¹⁰ − 119.47397λ⁹ + 698.93882λ⁸ −
2720.50250λ⁷ + 7400.15195λ⁶ −
14357.23666λ⁵ + 19873.42249λ⁴ − 19240.92948λ³ + 12415.09163λ² −
4807.95901λ + 847.46800
P(λ_{d}) = 1.000000e+00
P(λ_{C}) = 9.061300e−01
P(λ_{F}) = 1.194903e+00
6th Surface
K = −3.82019e+00 A4 = 4.72584e−05 A6 = 3.68312e−07
A8 = −4.49077e−09
7th Surface
K = −1.74933e+00 A4 = −1.45945e−05
8th Surface
K = 0.00000e+00 A4 = −4.52111e−04 A6 = −1.95257e−07

| Variable Distance | 0 m⁻¹ | −3 | +1 | −1 |
|---|---|---|---|---|
| d3 | 0.75 | 1.55 | 0.50 | 1.01 |
| d9 | 3.22 | 2.42 | 3.48 | 2.96 |

NUMERICAL EXAMPLE 7
UNIT: mm
Diopter: 0 m⁻¹
Focal Length f: 16.0 Pupil Diameter: 10
Diagonal Length of Display Surface: 9.98 Maximum Image Height: 4.99
SURFACE DATA

| Surface No. | r | d | nd | vd |
|---|---|---|---|---|
| 1 (EP) | ∞ | 19.00 | | |
| 2 | ∞ | 0.80 | 1.49171 | 57.4 |
| 3 | ∞ | (Variable) | | |
| 4 | ∞ | 1.00 | 1.45867 | 67.9 |
| 5 (diffraction) | ∞ | 0.50 | | |
| 6* | 11.791 | 7.96 | 1.64001 | 23.8 |
| 7* | 5.830 | 2.13 | | |
| 8* | 9.726 | 5.94 | 1.61883 | 60.4 |
| 9 | −14.252 | (Variable) | | |
| 10 | ∞ | 0.50 | 1.52310 | 65.0 |
| 11 | ∞ | 4.00 | | |
| 12 | ∞ | 0.70 | 1.51680 | 64.2 |
| 13 | ∞ | (Variable) | | |
| Display Surface | ∞ | | | |

ASPHERIC DATA
5th Surface (Diffractive surface) Designed Wavelength: 0.58756 [μm]
U2 = −8.39149e−03 U4 = 1.05774e−05 U6 = 3.06101e−07
Optical Path Difference Dispersion of Surface λ Unit: [μm]
P(λ) = −434.73044λ¹⁰ + 8122.08910λ⁹ −
67394.74965λ⁸ + 329209.06586λ⁷ −
1049750.44998λ⁶ + 2284260.64803λ⁵ −
3435917.19850λ⁴ + 3528102.09277λ³ −
2367044.44179λ² + 937029.43952λ − 166209.30017
P(λ_{d}) = 1.000000e+00
P(λ_{C}) = 9.218490e−01
P(λ_{F}) = 1.177334e+00
6th Surface
K = −1.29514e+00 A4 = −4.01519e−05
A6 = 7.95368e−07 A8 = −8.07760e−09
7th Surface
K = −1.36365e+00 A4 = −1.13348e−04
8th Surface
K = 0.00000e+00 A4 = −3.52583e−04 A6 = −1.37849e−06

| Variable Distance | 0 m⁻¹ | −3 | +1 | −1 |
|---|---|---|---|---|
| d3 | 0.75 | 1.55 | 0.50 | 1.01 |
| d9 | 3.23 | 2.42 | 3.48 | 2.97 |

TABLE 1

| | | inequality | | | | |
|---|---|---|---|---|---|---|
| | | 1 | 2 | 3 | 4 | 5 |
| | | 1/ν₀ | fmoe/f | fmenis/f | OL/f | 1/ν_{0, gF} |
| numerical | 1 | 0.00 | 1.18 | −2.12 | 0.84 | 0.000 |
| example | 2 | 0.00 | 0.81 | −3.00 | 1.16 | 0.000 |
| | 3 | 0.00 | 1.05 | 3.01 | 0.80 | 0.000 |
| | 4 | −0.01 | 2.38 | −1.57 | 1.06 | −0.002 |
| | 5 | 0.02 | 0.85 | −0.90 | 0.87 | 0.008 |
| | 6 | −0.02 | 2.82 | −1.72 | 1.06 | −0.004 |
| | 7 | −0.06 | 3.72 | −2.35 | 1.10 | −0.009 |

### Display Apparatus

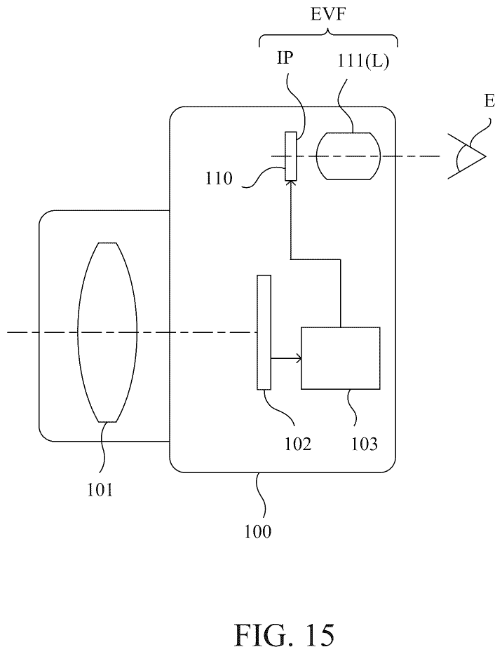

FIG. 15 illustrates the configuration of an image pickup apparatus (simply called a camera hereinafter) 100 such as a digital camera or video camera having an EVF as a display apparatus including the display optical system L according to any one of Examples 1 to 7.

The camera 100 includes an imaging optical system 101, an image sensor 102 such as a CCD sensor or CMOS sensor configured to capture (photoelectrically convert) an object image (not illustrated) through the imaging optical system 101, and an image processing unit 103 configured to generate image data using a signal output from the image sensor 102.

The image data generated by the image processing unit 103 is output to a display element 110 of the EVF. The display element 110 displays the object image corresponding to the image data on its display surface IP.

The EVF has a display element 110 according to any one of Examples 1 to 7. An eyepiece optical system 111 is provided, which includes the display optical system L according to any one of Examples 1 to 7. A user (observer) of the camera 100 can observe a magnified image of the object displayed on the display element 110 through the eyepiece optical system 111.

By using the display optical system L according to Examples 1 to 7 as the eyepiece optical system 111, an excellent object image can be observed with little image quality degradation caused by various aberrations such as lateral chromatic aberration and astigmatism.

The display optical system L according to any one of Examples 1 to 7 can also be used in display apparatuses other than the EVF, such as a head mount display (HMD).

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can effectively correct lateral chromatic aberration and astigmatism using a diffractive surface with a controlled wavelength dispersion characteristic in the display optical system.

This application claims priority to Japanese Patent Application No. 2023-140624, which was filed on Aug. 31, 2023, and which is hereby incorporated by reference herein in its entirety.

What is claimed is:

1. A display optical system comprising:
a diffractive surface with a controlled wavelength dispersion characteristic,
wherein the following equation is satisfied:
$$\frac{1}{{v}_{o}} = \frac{{ψ}_{F} - {ψ}_{C}}{{ψ}_{d}} = \frac{{λ}_{F} P ( {λ}_{F} ) - {λ}_{C} P ( {λ}_{C} )}{{λ}_{d} P ( {λ}_{d} )} ,$$
where ν₀ is an Abbe number of the diffractive surface, a reference wavelength is d-line, primary dispersion is F-line and C-line, Ψ_{d}, Ψ_{F}, and Ψ_{C} are optical path difference functions for the d-line, the F-line, and the C-line, respectively, λ_{d}, λ_{F}, and λ_{C} are incident wavelengths of the d-line, the F-line, and the C-line, respectively, P(λ_{d}), P(λ_{F}), and P(λ_{C}) are optical path difference dispersions of a surface for the d-line, the F-line, and the C-line, respectively, and
the following inequality is satisfied:
$$- 0.2 < 1 / {v}_{0} < 0.2 .$$

2. The display optical system according to claim 1, further comprising a refractive lens that does not have the diffractive surface.

3. The display optical system according to claim 2, wherein the refractive lens is a meniscus lens.

4. The display optical system according to claim 1, further comprising a lens having the diffractive surface and positive refractive power.

5. The display optical system according to claim 1, wherein the following equality is satisfied:
$$\frac{1}{{f}_{moe}} = - 2 m \frac{λ}{{λ}_{0}} P ( λ ) {U}_{2}$$
where fₘₒₑ is a focal length of the diffractive surface, m is a diffraction order of the diffractive surface, λ₀ is a designed wavelength, λ is an incident wavelength, P(λ) is an optical path difference dispersion of a surface at the incident wavelength, U₂ is a second-order coefficient of an optical path difference function of a surface at the designed wavelength, and
the following inequality is satisfied:
$$0.7 < {f}_{moe} / f < 4.0$$
where f is a focal length of the display optical system.

6. The display optical system according to claim 3, wherein the following inequality is satisfied:
$$- 4 < fmenis / f < 4$$
where fmenis is a focal length of the meniscus lens, and f is a focal length of the display optical system.

7. The display optical system according to claim 1, further comprising, in order from an observation side to a display surface side, a lens having positive refractive power, and a meniscus lens as a refractive lens that does not have the diffractive surface.

8. The display optical system according to claim 1, wherein the diffractive surface has a planar shape.

9. The display optical system according to claim 1, further comprising:
a lens having the diffractive surface; and
a refractive lens that does not have the diffractive surface,
where the following inequality is satisfied:
$$0.6 < OL / f < 1.4$$
where OL is a distance on an optical axis between a surface closest to a display surface and a surface farthest from the display surface among surfaces of the lens having the diffractive surface and the refractive lens, and f is a focal length of the display optical system.

10. The display optical system according to claim 1, wherein the following equation is satisfied:
$$\frac{1}{{v}_{0 , gF}} = \frac{{ψ}_{G} - {ψ}_{F}}{{ψ}_{d}} = \frac{{λ}_{q} P ( {λ}_{q} ) - {λ}_{F} P ( {λ}_{F} )}{{λ}_{d} P ( {λ}_{d} )}$$
where ν_{0,gF} is an Abbe number in a wavelength region below the F-line in a case where primary dispersion of the diffractive surface is g-line and the F-line, Ψ_{g} is an optical path difference function for the g-line, and λ_{g} is an incident wavelength of the g-line, and P(λ_{g}) is optical path difference dispersion of a surface for the g-line, and
the following inequality is satisfied:
$$- 0.02 < 1 / {v}_{0 , gF} < 0.02 .$$

11. The display optical system according to claim 1, further comprising a lens having the diffractive surface, and a refractive lens that does not have the diffractive surface, and the lens having the diffractive surface and the refractive lens are arranged next to each other.

12. The display optical system according to claim 1, further comprising a lens having the diffractive surface, and a refractive lens that does not have the diffractive surface,
wherein diopter adjustment is performed by moving the lens having the diffractive surface and the refractive lens.

13. A display optical system comprising:
a metasurface with a controlled wavelength dispersion characteristic,
wherein the following equation is satisfied:
$$\frac{1}{{v}_{o}} = \frac{{ψ}_{F} - {ψ}_{C}}{{ψ}_{d}} = \frac{{λ}_{F} P ( {λ}_{F} ) - {λ}_{C} P ( {λ}_{C} )}{{λ}_{d} P ( {λ}_{d} )} ,$$
where ν₀ is an Abbe number of the metasurface, a reference wavelength is d-line, primary dispersion is F-line and C-line, Ψ_{d}, Ψ_{F}, and Ψ_{C} are optical path difference functions for the d-line, the F-line, and the C-line, respectively, λ_{d}, λ_{F}, and λ_{C} are incident wavelengths of the d-line, the F-line, and the C-line, respectively, P(λ_{d}), P(λ_{F}), and P(λ_{C}) are optical path difference dispersions of a surface for the d-line, the F-line, and the C-line, respectively, and
the following inequality is satisfied:
$$- 0.2 < 1 / {v}_{0} < 0.2 .$$

14. A display apparatus comprising:
the display optical system according to claim 1; and
a display element having a display surface.

15. A display apparatus comprising:
the display optical system according to claim 13; and
a display element having a display surface.
